(19) United States
(12) Patent Application Publication
(10) Pub. No.: US 2010/0007678 A1
(43) Pub. Date: Jan. 14, 2010

(54) HANDHELD ELECTRICAL COMMUNICATION DEVICE AND IMAGE PROCESSING METHOD THEREOF

(75) Inventors: Chung-Ching TSAI, Hsinchu County (TW); Lin-Chung Tsai, Taoyuan County (TW); Han-Min Cheng, Hsinchu County (TW)

Correspondence Address: RABIN & Berdo, PC, 1101 14TH STREET, NW, SUITE 500, WASHINGTON, DC, 20005, US

(73) Assignee: Alpha Imaging Technology Corp., Hsinchu County (TW)

(21) Appl. No.: 12/482,692

(22) Filed: Jun. 11, 2009

(30) Foreign Application Priority Data
Jul. 10, 2008 (TW) 97126187

(51) Int. Cl. G09G 5/00; H04M 1/00

(52) U.S. Cl. 345/660; 455/556.1

(57) ABSTRACT

A handheld electrical communication device includes an image sensing unit, an image signal processing unit, a storage unit, a display unit and a baseband processing unit. The image sensing unit generates an original image frame. The image signal processing unit adjusts the original image frame to be an adjusted image frame, scales the adjusted image frame to be a scaled image frame, and compresses the adjusted image frame into compressed image data. The storage unit stores the compressed image data. The baseband processing unit reads and outputs the compressed image data from the storage unit to the image signal processing unit. The image signal processing unit decompresses the compressed image data to be the adjusted image frame, scales the adjusted image frame to be the scaled image frame and outputs the scaled image frame to the baseband processing unit. The scaled image frame is displayed on the display unit.

This application claims the benefit of Taiwan application Serial No. 97126187, filed Jul. 10, 2008, the subject matter of which is incorporated herein by reference.

### BACKGROUND OF THE INVENTION

1. Field of the Invention

The invention relates in general to a handheld electrical communication device and image processing method thereof, and more particularly to a handheld electrical communication device having a strong capability and image processing method thereof.

2. Description of the Related Art

Referring to FIG. 1, a schematic diagram of a conventional mobile phone is shown. The mobile phone 100 includes an optical sensor 110, an image signal processing chip 120, a baseband chip 130, a memory card 140 and a liquid crystal panel 150. The optical sensor 110 is coupled to the image signal processing chip 120 via a consultative committee of international radio (CCIR) bus, and the image signal processing chip 120 is coupled to the baseband chip 130 via another CCIR bus. These CCIR buses are both unidirectional buses. The optical sensor 110 is for generating a number of original image frames and the original image frames are raw image frames. The optical sensor 110 transmits the original image frames to the image signal processing chip 120.

Referring to FIG. 2, a block diagram of a conventional image signal processing chip is shown. The image signal processing chip 120 includes a CCIR receiver 121, an image processing engine 122, a scaling engine 123, a joint photographic experts group (JPEG) encoder 124 and a CCIR transmitter 125. The image signal processing chip 120 receives a number of original image frames from the optical sensor 110 via the CCIR receiver 121. The image processing engine 122 performs image processing operations, such as automatic exposure, automatic white balance or automatic focusing, on the original image frames to obtain a number of adjusted image frames. The scaling engine 123 scales the adjusted image frames according to a resolution of the liquid crystal panel 150 to obtain a number of scaled image frames and outputs the scaled image frames to the baseband chip 130. The baseband chip 130 displays the scaled image frames on the liquid crystal panel 150.

At the same time, according to a photographing command, the JPEG encoder 124 compresses one of the adjusted image frames into compressed image data based on a static image compression standard (JPEG). The CCIR transmitter 125 transmits the compressed image data to the baseband chip 130. The baseband chip 130 stores the compressed image data into the memory card 140. Afterwards, when the compressed image data is to be checked, the baseband chip 130 reads the compressed image data from the memory card 140, decompresses the compressed image data to be the adjusted image frame, and then scales the adjusted image frame according to the resolution of the liquid crystal panel 150 for displaying on the liquid crystal panel 150.

However, along with an increasing number of image pixels of a camera configured on the mobile phone 100, the resolution of the original image frames generated by the optical sensor 110 is increased, and thus the size of the compressed image data obtained by the JPEG encoder 130 is also enlarged, which leads to a result that the baseband chip 130 fails to decompress the compressed image data after reading the compressed image data from the memory card 140, and thus fails to display image frames on the liquid crystal panel 150. Although the above problem can be solved by adding external circuit elements, such as an external memory interface (EMI) or memory mapped peripherals (MMP) to the baseband chip 130, this method is not applicable to an integrated structure.

### SUMMARY OF THE INVENTION

The invention is directed to a handheld electrical communication device, and image processing method thereof, which transmits the compressed image data to the image signal processing unit for decompression by using an extra bus such that the baseband processing unit can display the corresponding image frame on the display unit.

According to a first aspect of the present invention, a handheld electrical communication device is provided. The handheld electrical communication device comprises an image sensing unit, an image signal processing unit, a storage unit, a display unit and a baseband processing unit. The image sensing unit is for generating an original image frame. The image signal processing unit is for adjusting the original image frame to be an adjusted image frame, scaling the adjusted image frame to be a scaled image frame, and compressing the adjusted image frame into compressed image data. The storage unit is for storing the compressed image data. The baseband processing unit reads and outputs the compressed image data from the storage unit to the image signal processing unit, the image signal processing unit decompresses the compressed image data to be the adjusted image frame, scales the adjusted image frame to be the scaled image frame and outputs the scaled image frame to the baseband processing unit, and the baseband processing unit displays the scaled image frame on the display unit.

According to a second aspect of the present invention, an image processing method for a handheld electrical communication device is provided. The handheld electrical communication device comprises an image sensing unit, an image signal processing unit, a storage unit, a display unit and a baseband processing unit. The image processing method comprises: generating an original image frame by the image sensing unit; adjusting the original image frame to be an adjusted image frame, scaling the adjusted image frame to be a scaled image frame, and compressing the adjusted image frame into compressed image data by the image signal processing unit; storing the compressed image data in a storage unit; reading and outputting the compressed image data from the storage unit to the image signal processing unit by the baseband processing unit; decompressing the compressed image data to be the adjusted image frame and scaling the adjusted image frame to be the scaled image frame and outputting the scaled image frame to the baseband processing unit by the image signal processing unit; and displaying the scaled image frame on the display unit by the baseband processing unit.

The invention will become apparent from the following detailed description of the preferred but non-limiting embodiments. The following description is made with reference to the accompanying drawings.

### BRIEF DESCRIPTION OF THE DRAWINGS

FIG. 1 is a schematic diagram of a conventional mobile phone.

FIG. 2 is a block diagram of a conventional image signal processing chip.

FIG. 3 is a block diagram of a handheld electrical communication device according to the first embodiment of the invention.

FIG. 4 is a block diagram of the image signal processing unit according to the first embodiment of the invention.

FIG. 5 is a block diagram of a handheld electrical communication device according to the second embodiment of the invention.

FIG. 6 is a block diagram of the image signal processing unit according to the second embodiment of the invention.

FIG. 7 is a block diagram of a handheld electrical communication device according to the third embodiment of the invention.

FIG. 8 is a block diagram of the image signal processing unit according to the third embodiment of the invention.

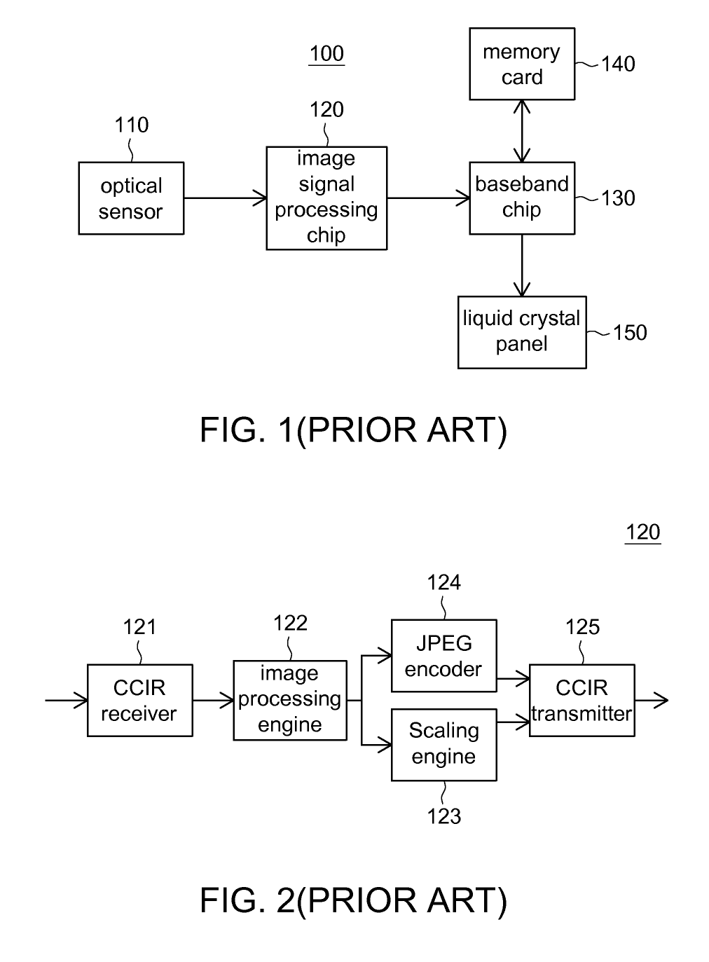

### DETAILED DESCRIPTION OF THE INVENTION

The invention is directed to a handheld electrical communication device, and image processing method thereof, which uses an extra bus coupled between the image processing unit and the baseband processing unit to transmit the compressed image data to the image signal processing unit for decompression such that the baseband processing unit can display the corresponding image frame on the display unit.

### The First Embodiment

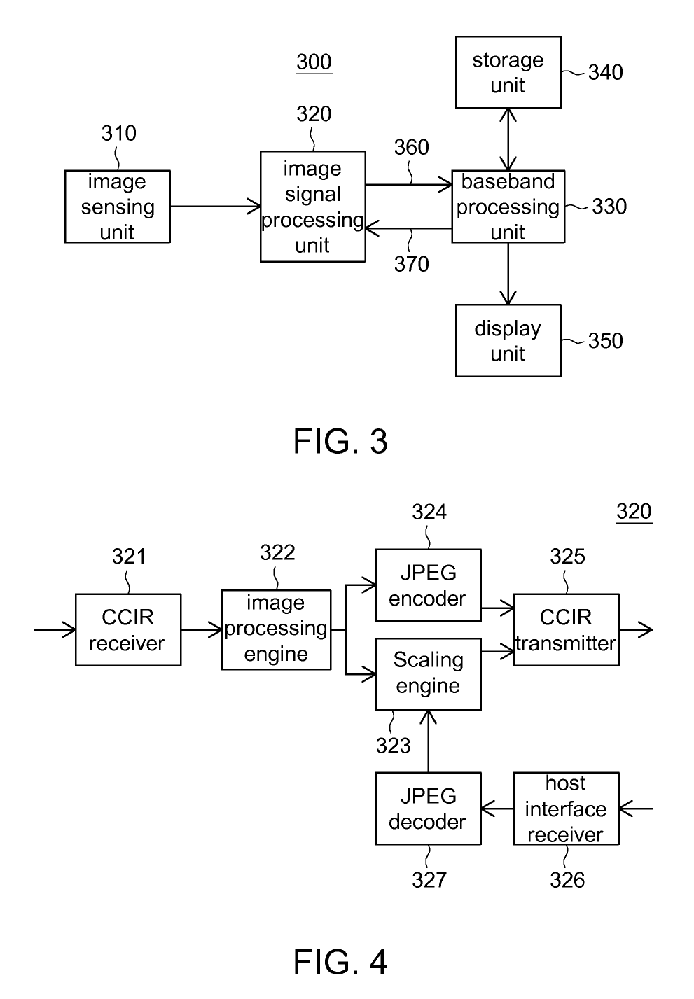

Referring to FIG. 3, a block diagram of a handheld electrical communication device according to the first embodiment of the invention is shown. The handheld electrical communication device 300, such as a mobile phone, includes an image sensing unit 310, an image processing unit 320, a baseband processing unit 330, a storage unit 340 and a display unit 350. The image signal processing unit 320 communicates with the baseband processing unit via a unidirectional first bus 360. For example, the first bus 360 is a consultative committee of international radio (CCIR) parallel bus, a standard mobile imaging architecture (SMIA) serial bus or a mobile industry processor interface (MIPI) serial bus. The first bus 360 can be used for transmitting a large amount of data. The baseband processing unit 330 communicates with the image signal processing unit 320 via a second bus 370, and the second bus 370 can be a serial or parallel bus.

In the handheld electrical communication device 300, for example, the image sensing unit 310 and the image signal processing unit 320 are disposed in a camera module (not shown in the figure) of the handheld electrical communication device 300, and the baseband processing unit 330, the storage unit 340 and the display unit 350 are disposed on a printed circuit board (not shown in the figure) of the handheld electrical communication device 300. However, the invention is not limited thereto. In another example, the image sensing unit 310 is disposed in the camera module of the handheld electrical communication device 300, while the image signal processing unit 320, the baseband processing unit 330, the storage unit 340 and the display unit 350 are disposed on the printed circuit board of the handheld electrical communication device 300, wherein the camera module is coupled to the printed circuit board via a flexible printed circuit board.

For example, the image sensing unit 310 is a complementary metal oxide semiconductor (CMOS) sensor or a charge coupled device (CCD) sensor for generating a number of original image frames. The original image frames are raw image frames, such as static images. The image sensing unit 310 transmits the original image frames to the image signal processing unit 320.

The image signal processing unit 320 is an image signal processing chip for instance. Referring to FIG. 4, a block diagram of the image signal processing unit according to the first embodiment of the invention is shown. The image signal processing unit 320 includes a CCIR receiver 321, an image processing engine 322, a scaling engine 323, a JPEG encoder 324, a CCIR transmitter 325, a host interface receiver 326 and a JPEG decoder 327. The image signal processing unit 320 receives a number of original image frames from the image sensing unit 310 via the CCIR receiver 321.

The image processing engine 322 performs image processing operations, such as automatic exposure, automatic white balance or automatic focusing, on the original image frames to obtain a number of adjusted image frames. The scaling engine 323 scales the adjusted image frames according to a resolution of the display unit 350 to obtain a number of scaled image frames. The scaled image frames are YUV/RGB image frames for instance. The CCIR transmitter 325 outputs the scaled image frames to the baseband processing unit 330 via the first bus 360. The baseband processing unit 330 displays the scaled image frames on the display unit 350.

At the same time, according to a photographing command, the JPEG encoder 324 compresses one of the adjusted image frames into compressed image data based on a static image compression standard (JPEG). The CCIR transmitter 325 transmits the compressed image data to the baseband processing unit 330. The baseband processing unit 330 stores the compressed image data into the storage unit 340. Afterwards, when the compressed image data is to be checked, the baseband processing unit 330 reads and outputs the compressed image data from the storage unit 340 to the image signal processing unit 320 via the second bus 370.

The image signal processing unit 320 receives the compressed image data by the host interface receiver 326, and then the JPEG decoder 327 decompresses the compressed image data to obtain the adjusted image frame based on the static image compression standard (JPEG). The scaling engine 323 scales the adjusted image frame to obtain the scaled image frame, and the CCIR transmitter 325 transmits the scaled image frame to the baseband processing unit 330 via the first bus 360. The baseband processing unit 330 displays the scaled image frame on the display unit 350.

In the above-mentioned handheld electrical communication device 300 of the first embodiment of the invention, the compressed image data can be transmitted to the JPEG decoder 327 of the image signal processing unit 320 for decompression by the second bus 370 coupled between the image signal processing unit 320 and the baseband processing unit 330. By this way, the baseband processing unit 330 can display the decompressed and scaled image frames on the display unit 350.

### The Second Embodiment

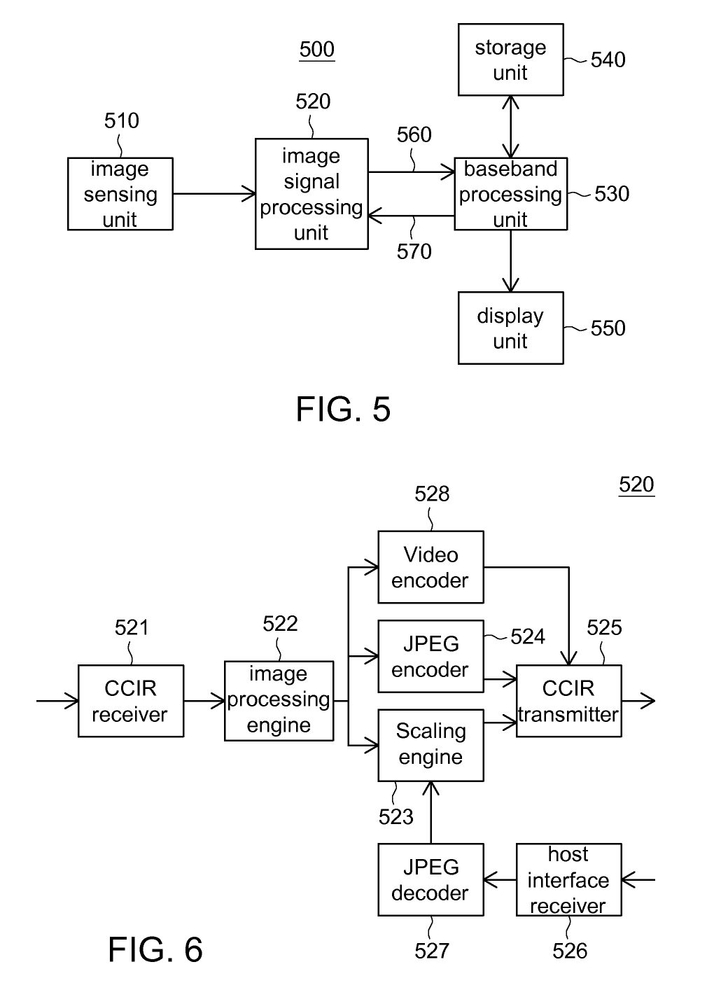

Referring to FIG. 5, a block diagram of a handheld electrical communication device according to the second embodiment of the invention is shown. The handheld electrical communication device 500 includes an image sensing unit 510, an image processing unit 520, a baseband processing unit 530, a storage unit 540 and a display unit 550. The image signal processing unit 520 communicates with the baseband processing unit 530 via a unidirectional first bus 560. The baseband processing unit 530 communicates with the image signal processing unit 520 via a second bus 570.

The difference between the handheld electrical communication device 500 of the second embodiment and the handheld electrical communication device 300 of the first embodiment lies in the image signal processing unit 520. Referring to FIG. 6, a block diagram of the image signal processing unit according to the second embodiment of the invention is shown. Compared with the image signal processing unit 320, the image signal processing unit 520 has similar functions except for an extra video encoder 528. When the original image frames generated by the image sensing unit 510 are dynamic images, the video encoder 528 compresses a number of adjusted image frames obtained by the image processing engine 522 to be a number of compressed image data based on a dynamic image compression standard (H264/MPEG4). At the same time, the scaling engine 323 scales the adjusted image frames according to a resolution of the display unit 550 to obtain a number of scaled image frames.

The CCIR transmitter 525 receives the scaled image frames from the scaling engine 523 and receives the compressed image data from the video encoder 528. Then, the CCIR transmitter 525 sequentially and alternately outputs the scaled image frames and the compressed image data to the baseband processing unit 530 via the first bus 560. The baseband processing unit 530 stores the compressed image data in the storage unit 540 and displays the scaled image frames on the display unit 550.

Compared with the handheld electrical communication device 300, the handheld electrical communication device 500 of the second embodiment can not only decompress the compressed image data of static images, but also encode the original image frames of dynamic images by the video encoder 528 of the image signal processing unit 520 without altering the structure of the baseband processing unit 530.

### The Third Embodiment

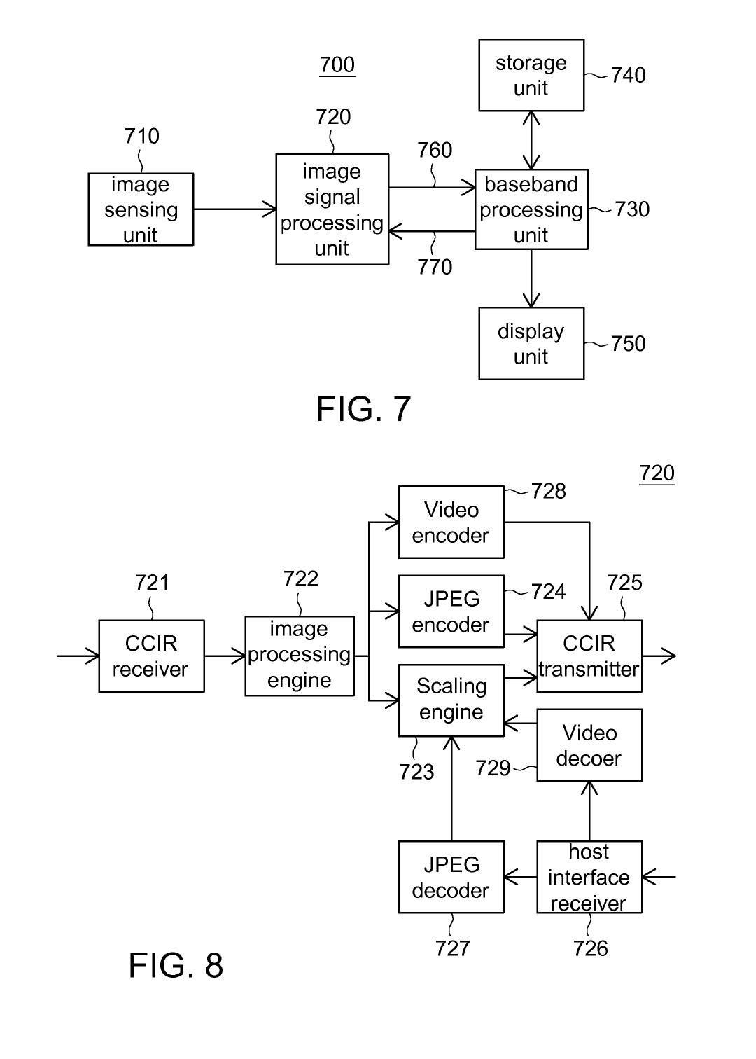

Referring to FIG. 7, a block diagram of a handheld electrical communication device according to the third embodiment of the invention is shown. The handheld electrical communication device 700 includes an image sensing unit 710, an image processing unit 720, a baseband processing unit 730, a storage unit 740 and a display unit 750. The image signal processing unit 720 communicates with the baseband processing unit 730 via a unidirectional first bus 760. The baseband processing unit 730 communicates with the image signal processing unit 720 via a second bus 770.

The difference between the handheld electrical communication device 700 of the third embodiment and the handheld electrical communication device 500 of the second embodiment lies in the image signal processing unit 720. Referring to FIG. 8, a block diagram of the image signal processing unit according to the third embodiment of the invention is shown. Compared with the image signal processing unit 520, the image signal processing unit 720 has similar functions except for an extra video decoder 729. When the original image frames generated by the image sensing unit 710 are dynamic images, the video encoder 728 compresses a number of adjusted image frames obtained by the image processing engine 722 to be a number of compressed image data based on a dynamic image compression standard. At the same time, the scaling engine 723 scales the adjusted image frames according to a resolution of the display unit 750 to obtain a number of scaled image frames.

The CCIR transmitter 725 sequentially and alternately outputs the scaled image frames and the compressed image data to the baseband processing unit 730 via the first bus 760. The baseband processing unit 730 stores the compressed image data in the storage unit 740. Following that, when the compressed image data is to be checked, the baseband processing unit 730 reads and outputs the compressed image data from the storage unit 740 to the image signal processing unit 720 via the second bus 770. The image signal processing unit 720 receives the compressed image data via a host interface receiver 726, and then the video decoder 729 decompresses the compressed image data to obtain a number of adjusted image frames based on a dynamic image compression standard (H264/MPEG4). The scaled engine 723 scales the adjusted image frames to obtain a number of scaled image frames. The CCIR transmitter 725 outputs the scaled image frames to the baseband processing unit 730 via the first bus 760. The baseband processing unit 730 displays the scaled image frames on the display unit 750.

The handheld electrical communication device 700 of the third embodiment can not only decompress the compressed image data of static images, but also encode and decode the original image frames of dynamic images by the video encoder 728 and video decoder 729 of the image signal processing unit 720 without altering the structure of the baseband processing unit 730.

Besides, the invention also provides an image processing method for a handheld electrical communication device. The handheld electrical communication device includes an image sensing unit, an image signal processing unit, a storage unit, a display unit and a baseband processing unit. The image processing method includes the following steps. Generate an original image frame by the image sensing unit. Adjust the original image frame to be an adjusted image frame, scale the adjusted image frame to be a scaled image frame and compress the adjusted image frame into compressed image data by the image signal processing unit. Store the compressed image data in a storage unit. Read and output the compressed image data from the storage unit to the image signal processing unit by the baseband processing unit. Decompress the compressed image data to be the adjusted image frame, scale the adjusted image frame to be the scaled image frame and output the scaled image frame to the baseband processing unit by the image signal processing unit. Display the scaled image frame on the display unit by the baseband processing unit. The operational principle of the above image processing method for a handheld electrical communication device has been described in the handheld electrical communication devices 300, 500 and 700. Thus, any detail is not necessarily given here.

The handheld electrical communication device and image processing method thereof disclosed by the above embodiments of the invention use an extra bus coupled between the image signal processing unit and the baseband processing unit for transmitting the compressed image data to the image signal processing unit and use the image signal processing unit for compression and decompression operations. Therefore, the invention can not only decode the compressed image data of static images of high resolution, but also encode and decode the original image frames of dynamic images such that the baseband processing unit can display the corresponding image frames on the display unit.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A handheld electrical communication device, comprising:
an image sensing unit, for generating an original image frame;
an image signal processing unit, for adjusting the original image frame to be an adjusted image frame, scaling the adjusted image frame to be a scaled image frame, and compressing the adjusted image frame into compressed image data;
a storage unit, for storing the compressed image data;
a display unit; and
a baseband processing unit;
wherein the baseband processing unit reads and outputs the compressed image data from the storage unit to the image signal processing unit, the image signal processing unit decompresses the compressed image data to be the adjusted image frame, scales the adjusted image frame to be the scaled image frame and outputs the scaled image frame to the baseband processing unit, and the baseband processing unit displays the scaled image frame on the display unit.

2. The handheld electrical communication device according to claim 1, further comprising a first bus and a second bus, wherein the baseband processing unit outputs the compressed image data to the image signal processing unit via the second bus, and the image signal processing unit outputs the scaled image frame to the baseband processing unit via the first bus.

3. The handheld electrical communication device according to claim 2, wherein the first but is a consultative committee of international radio (CCIR) parallel bus, a standard mobile imaging architecture (SMIA) serial bus or a mobile industry processor interface (MIPI) serial bus.

4. The handheld electrical communication device according to claim 2, wherein the image signal processing unit comprises:
a host interface receiver, for receiving the compressed image data read by the baseband processing unit from the storage unit; and
a first decoder, for decompressing the compressed image data to be the adjusted image frame.

5. The handheld electrical communication device according to claim 4, wherein the image signal processing unit compresses the adjusted image frame to be the compressed image data based on a static image compression standard (JPEG) according to a photographing command, and the first decoder decompresses the compressed image data to be the adjusted image frame according to the static image compression standard.

6. The handheld electrical communication device according to claim 1, wherein the image sensing unit is further for generating a plurality of original image frames, the image signal processing unit is further for adjusting the original image frames to be a plurality of adjusted image frames, scaling the adjusted image frames to be a plurality of scaled image frames and sequentially outputting the scaled image frames to the baseband processing unit, and compressing the adjusted image frames into a plurality of compressed image data and sequentially outputting the compressed image data to the baseband processing unit, wherein the scaled image frames and the compressed image data are alternately outputted to the baseband processing unit, and the baseband processing unit stores the compressed image data in the storage unit and displays the scaled image frames on the display unit.

7. The handheld electrical communication device according to claim 6, wherein the image signal processing unit comprises:
a first encoder, for compressing the adjusted image frames to be the compressed image data based on a dynamic image compression standard (H264/MPEG4).

8. The handheld electrical communication device according to claim 6, wherein the baseband processing unit reads and outputs the compressed image data from the storage unit to the image signal processing unit, the image signal processing unit decompresses the compressed image data to be the adjusted image frames, scales the adjusted image frames to be the scaled image frames and outputs the scaled image frames to the baseband processing unit, and the baseband processing unit displays the scaled image frames on the display unit.

9. The handheld electrical communication device according to claim 8, wherein the image signal processing unit comprises:
a host interface receiver, for receiving the compressed image data read by the baseband processing unit from the storage unit; and
a second decoder, for decompressing the compressed image data to be the adjusted image frames based on a dynamic image compression standard (H264/MPEG4).

10. The handheld electrical communication device according to claim 1, wherein the image sensing unit and the image signal processing unit are disposed in a camera module of the handheld electrical communication device, the storage unit, the display unit and the baseband processing unit are disposed on a printed circuit board of the handheld electrical communication device, and the camera module is coupled to the printed circuit board via a flexible printed circuit board.

11. The handheld electrical communication device according to claim 1, wherein the image sensing unit is disposed in a camera module of the handheld electrical communication device, the image signal processing unit, the storage unit, the display unit and the baseband processing unit are disposed on a printed circuit board of the handheld electrical communication device, and the camera module is coupled to the printed circuit board via a flexible printed circuit board.

12. An image processing method for a handheld electrical communication device, the handheld electrical communication device comprising an image sensing unit, an image signal processing unit, a storage unit, a display unit and a baseband processing unit, the image processing method comprising:
generating an original image frame by the image sensing unit;
adjusting the original image frame to be an adjusted image frame, scaling the adjusted image frame to be a scaled image frame, and compressing the adjusted image frame into compressed image data by the image signal processing unit;
storing the compressed image data in a storage unit;
reading and outputting the compressed image data from the storage unit to the image signal processing unit by the baseband processing unit;
decompressing the compressed image data to be the adjusted image frame and scaling the adjusted image frame to be the scaled image frame and outputting the scaled image frame to the baseband processing unit by the image signal processing unit; and
displaying the scaled image frame on the display unit by the baseband processing unit.

13. The image processing method according to claim 12, wherein the handheld electrical communication device further comprises a first bus and a second bus, the compressed image data is outputted from the baseband processing unit to the image signal processing unit via the second bus, and the scaled image frame is outputted from the image signal processing unit to the baseband processing unit via the first bus.

14. The image processing method according to claim 13, wherein the first bus is a consultative committee of international radio (CCIR) parallel bus, a standard mobile imaging architecture (SMIA) serial bus or a mobile industry processor interface (MIPI) serial bus.

15. The image processing method according to claim 12, wherein the image signal processing unit comprises a host interface receiver and a first decoder, the image processing method further comprises:
receiving the compressed image data read by the baseband processing unit from the storage unit by the host interface receiver; and
decompressing the compressed image data to be the adjusted image frame by the first decoder.

16. The image processing method according to claim 15, wherein the image signal processing unit compresses the adjusted image frame to be the compressed image data based on a static image compression standard (JPEG) according to a photographing command, and the first decoder decompresses the compressed image data to be the adjusted image frame according to the static image compression standard.

17. The image processing method according to claim 12, further comprising:
generating a plurality of original image frames by the image sensing unit;
adjusting the original image frames to be a plurality of adjusted image frames, scaling the adjusted image frames to be a plurality of scaled image frames and sequentially outputting the scaled image frames to the baseband processing unit, and compressing the adjusted image frames into a plurality of compressed image data and sequentially outputting the compressed image data to the baseband processing unit by the image signal processing unit, wherein the scaled image frames and the compressed image data are alternately outputted to the baseband processing unit; and
storing the compressed image data in the storage unit and displaying the scaled image frames on the display unit by the baseband processing unit.

18. The image processing method according to claim 17, wherein the image signal processing unit comprises a first encoder, the image processing method further comprises:
compressing the adjusted image frames to be the compressed image data based on a dynamic image compression standard (H264/MPEG4) by the first encoder.

19. The image processing method according to claim 17, wherein the baseband processing unit is used for reading and outputting the compressed image data from the storage unit to the image signal processing unit, the image signal processing unit is used for decompressing the compressed image data to be the adjusted image frames, scaling the adjusted image frames to be the scaled image frames and outputting the scaled image frames to the baseband processing unit, and the baseband processing unit is used for displaying the scaled image frames on the display unit.

20. The image processing method according to claim 19, wherein the image signal processing unit comprises a host interface receiver and a second decoder, the image processing method further comprises:
receiving the compressed image data read by the baseband processing unit from the storage unit by the host interface receiver; and
decompressing the compressed image data to be the adjusted image frames based on a dynamic image compression standard (H264/MPEG4) by the second decoder.

21. The image processing method according to claim 12, wherein the image sensing unit and the image signal processing unit are disposed in a camera module of the handheld electrical communication device, the storage unit, the display unit and the baseband processing unit are disposed on a printed circuit board of the handheld electrical communication device, and the camera module is coupled to the printed circuit board via a flexible printed circuit board.

22. The image processing method according to claim 12, wherein the image sensing unit is disposed in a camera module of the handheld electrical communication device, the image signal processing unit, the storage unit, the display unit and the baseband processing unit are disposed on a printed circuit board of the handheld electrical communication device, and the camera module is coupled to the printed circuit board via a flexible printed circuit board.
